(19) United States
(12) Patent Application Publication
(10) Pub. No.: US 2016/0379793 A1
(43) Pub. Date: Dec. 29, 2016

(54) BEAM FOCUSING AND ACCELERATING SYSTEM

(71) Applicant: THE QUEEN'S UNIVERSITY OF BELFAST, Belfast (GB)

(72) Inventor: Satyabrata Kar, Belfast (GB)

(73) Assignee: The Queen's University of Belfast, Belfast (GB)

(21) Appl. No.: 15/111,557

(22) PCT Filed: Jan. 15, 2015
(86) PCT No.: PCT/EP2015/050719

§ 371 Date: Jul. 14, 2016

(30) Foreign Application Priority Data
Jan. 16, 2014 (GB) 1400727.2

(51) Int. Cl. H01J 29/58; H01J 27/24; H01J 29/84; H01J 29/80; H05H 7/12; H05H 7/08; H01J 27/02

(52) U.S. Cl. CPC H01J 29/58; H05H 7/08; H01J 27/24; H01J 27/022; H01J 29/803; H05H 7/12; H01J 29/84; H05H 2007/082; H05H 2007/122

(57) ABSTRACT

A system for focusing and accelerating a beam of electrically charged particles, for example protons. The system comprises: a beam generator; a charge pulse generator; and a focusing and accelerating device comprising a body with a core. The body defines a charge path extending along the body and beam generator directs a beam of electrically charged particles through the core. The charge pulse generator simultaneously delivers charge pulses to the charge path. The charge path may be helical in shape. Movement of the charge pulse along the path creates an electric field that simultaneously accelerates and focuses the beam.

### FIELD OF THE INVENTION

The present invention relates to manipulating beams, in particular beam focusing and accelerating. The invention relates particularly to focusing and accelerating ion beams, especially but not exclusively proton beams.

### BACKGROUND TO THE INVENTION

There is a growing interest in laser based ion accelerators because of their cost effectiveness and compactness. Most experimental research so far has dealt with a laser driven ion acceleration technique known as Target Normal Sheath Acceleration (TNSA), where ions are accelerated by space charge fields set up by relativistic electrons at target surfaces. TNSA driven ion beams have proper ties, such as brightness, laminarity and pulse duration, which are markedly different from those of more conventional accelerator beams. However, overcoming some of the inherent shortcomings of laser accelerated proton beams, such as broad energy spectrum and large beam divergence, poses significant scientific and technological challenges.

The inherent divergence of TNSA ion beams (typically 40°-60°, depending on laser and target parameters) makes it difficult to utilize the full flux of the proton beam in application, and for further transport and beam manipulation. In order to maintain a suitably high ion flux over the distances required by typical applications, such as radiobiology, material damage studies, warm dense matter creation and neutron source development, some means of constraining the beam divergence is needed. The manipulation of laser generated proton beams presents specific challenges due to the high bunch charge and short pulse nature of the beams. Conventional ion optics (e.g. quadrupole pairs) and pulsed solenoids have been applied by a number of groups with some degree of success, however the use of these techniques limits the number of particles that can be delivered, and requires relatively large propagation distances, which stretches the selected bunch beyond the requirements of many of the applications mentioned above.

It would be desirable therefore to provide improvements in beam control and optimisation, and in particular to provide a proton beam with improved beam parameters, and to deliver a beam of accelerator standard for widespread applications.

### SUMMARY OF THE INVENTION

A first aspect of the invention provides a system for focusing and accelerating a beam of electrically charged particles, the system comprising: a beam generator for generating said beam; at least one charge pulse generator for generating at least one electrical charge pulse; at least one focusing and accelerating device comprising a body with a core, said body defining a charge path extending along said body, wherein said beam generator is arranged to direct said beam through said core, and wherein said at least one charge pulse generator is coupled to said body to deliver said at least one charge pulse to said charge path. Advantageously, said at least one charge pulse focuses and accelerates the or each electrically charged particle in said core, and this is preferably achieved by synchronising the movement of said at least one charge pulse along said charge path with the passage of the or each electrically charged particle along the core.

Typically, said body comprises electrically conductive material shaped to define said charge path. Said charge path preferably extends around the longitudinal axis of said core. Said charge path typically comprises at least one loop, preferably a plurality of loops mutually spaced apart in the direction of the longitudinal axis of said core. Adjacent loops may be spaced apart to define a gap therebetween, or may be contiguous.

In preferred embodiments, said charge path is substantially helical in shape, for example the loops may be joined to one another to form a helical structure.

Each loop may connected to the, or each, adjacent loop by a respective link member. Each loop may comprise a ring. The loops are typically concentric. In preferred embodiments, said at least one loop extends around the longitudinal axis of said core. The core may be hollow or solid.

In preferred embodiments, the body comprises a coil, preferably a helical coil, said coil being shaped to define said charge path. Alternatively the body comprises a plurality of rings. Each ring may be connected to the, or each, adjacent ring by a respective link. The rings may be concentric. Preferably at least some and preferably all of said rings are closed.

Typically the coil, rings and/or link as applicable are formed from electrically conductive material.

In preferred embodiments said beam generator comprises a charged particle accelerator, for example a laser driven ion accelerator. Typically said beam generator comprises a laser targeted on a first, for example obverse, surface of a target to cause said beam to emanate from a second, for example reverse, surface of said target, said target being aligned with an open end of said core so that said beam is directed into said core via said open end.

In preferred embodiments, said at least one charge pulse generator comprises a charged particle accelerator, for example a laser driven ion accelerator. Typically, said at least one charge pulse generator comprises a laser targeted on a first, for example obverse, surface of a target structure, said target structure being coupled to said charge path.

Optionally, said target structure is connected, preferably electrically connected during use at least, to said charge path.

The beam generator and said at least one charge pulse generator may be provided in combination by a laser driven ion accelerator.

In some embodiments, the beam generator and said at least one charge pulse generator are provided in combination by a laser targeted on a first, for example obverse, surface of a target structure to cause said beam to emanate from a second, for example reverse, surface of said target structure, said target structure being aligned with an open end of said core so that said beam is directed into said core via said open en, said target structure being coupled to said charge path.

The target structure may for example comprises a foil or wire or other target material.

Said beam typically comprises an ion beam, for example a proton beam.

Optionally the system comprises one or more additional focusing and accelerating devices aligned with a first focusing and accelerating device. A respective charge pulse generator may be coupled to each focusing and accelerating device.

The charge pulse generator is typically coupled to a first end of said charge path. The other end of said charge path may be coupled to a support member, said support member optionally being electrically conductive to provide an electrical connection between said other end of said charge path and electrical ground.

In some embodiments, said charge pulse generator is coupled to a first end of said coil.

The other end of said coil may be coupled to a support member, said support member optionally being electrically conductive to provide an electrical connection between said other end of said coil and electrical ground.

Typically the system includes means for controlling said beam and the delivery of said at least one charge pulse to synchronise the passage of at least some of said electrically charged particles through said core with the passage of said at least one charge pulse along said charge path.

Typically, said beam generator is operable to produce said beam in pulses. Preferably, said charge pulse generator is operable to deliver said at least one charge pulse to said charge path one at a time.

In preferred embodiments the system includes means for controlling the delivery of said at least one charge pulse to said charge path, preferably such that only one charge pulse is present in said charge path at a time.

The system preferably includes means for controlling said beam generator such that only one pulse of said beam is present in said core at a time.

The system preferably includes means for controlling said beam and the delivery of said at least one charge pulse to synchronise the passage of a pulse of said beam through said core with the passage of a charge pulse along said charge path.

Optionally the shape and/or size of said charge path is selected to facilitate synchronisation of the passage of at least some of said electrically charged particles through said core with the passage of said at least one charge pulse along said charge path.

Optionally the shape and/or size of said charge path is selected to facilitate synchronisation of the passage of a pulse of said beam through said core with the passage of a charge pulse along said charge path.

The spacing, or pitch, between adjacent loops may substantially constant along all or part of the length of the core. The width, or diameter, of said loops may be substantially constant along all or part of the length of said core. Alternatively, the spacing, or pitch, between adjacent loops may vary along all of part of the length of the core. In some embodiments the spacing between adjacent loops increases in a forward longitudinal direction. Optionally the width, or diameter, of said loops varies along all or part of the length of said core. For example, the width, or diameter, of said loops may decrease in a forward longitudinal direction.

In some embodiments, said body, or at least said charge path, is substantially cylindrical or substantially conical in shape alone all or part of the length of the body.

In some embodiments said loops are not interconnected and said at least one charge pulse generator is configured to deliver a respective charge pulse to each loop. Said at least one charge pulse generator may be configured to deliver said respective charge pulse in sequence in the longitudinal direction of said body.

In some embodiments said beam comprises charged particles with different energies, and wherein said controlling means is configured to synchronise the passage of at least some of said electrically charged particles within a selected energy range through said core with the passage of said at least one charge pulse along said charge path.

Optionally the, or each, target or target structure is electrically connected to electrical ground, preferably at an end of said body opposite where said at least one charge pulse is delivered in use to said charge path.

Optionally said body is electrically connected to electrical ground, preferably at an end of said body opposite where said at least one charge pulse is delivered in use to said charge path.

A second aspect of the invention provides a method of focusing and accelerating a beam of electrically charged particles using a focusing and accelerating device comprising a body with a core, said body defining a charge path extending along said body, the method comprising: generating said beam; generating at least one electrical charge pulse; directing said beam through said core, and delivering said at least one charge pulse to said charge path.

The preferred method includes causing said at least one charge pulse to focus and accelerate the or each electrically charged particle in said core, preferably by synchronising the movement of said at least one charge pulse along said charge path with the passage of the or each electrically charged particle along the core.

A third aspect of the invention provides a system for performing energy selection on a beam of electrically charged particles with different energies, the system comprising: a beam generator for generating said beam; at least one charge pulse generator for generating at least one electrical charge pulse; at least one energy selection device comprising a body with a core, said body defining a charge path extending along said body, wherein said beam generator is arranged to direct said beam through said core, and wherein said at least one charge pulse generator is coupled to said body to deliver said at least one charge pulse to said charge path.

A fourth aspect of the invention provides a method of performing energy selection on a beam of electrically charged particles using an energy selection device comprising a body with a core, said body defining a charge path extending along said body, the method comprising: generating said beam; generating at least one electrical charge pulse; directing said beam through said core, and delivering said at least one charge pulse to said charge path.

In preferred embodiments, it is found that the interaction of relatively intense lasers with metallic foil targets creates extremely high target potential due to the escape of fast electrons from the interaction region. In preferred embodiments, the resulting electric field is harnessed to act simultaneously as an accelerating, focusing and energy selection device.

Further advantageous aspects of the invention will be apparent to those ordinarily skilled in the art upon review of the following description of a specific embodiment and with reference to the accompanying drawings.

### BRIEF DESCRIPTION OF THE DRAWINGS

Embodiments of the invention are now described by way of example and with reference to the accompanying drawings in which like numerals are used to denote like parts and in which:

FIG. 1 is a block diagram of a beam focusing and accelerating system embodying one aspect of the invention;

FIG. 2 is a schematic diagram of a preferred beam focusing and accelerating system embodying one aspect of the invention;

FIG. 3 is a graph illustrating an example of the beam focusing effect achieved by a specific embodiment of the invention;

FIG. 4 is a graph illustrating an example of the beam accelerating effect achieved by a specific embodiment of the invention;

FIGS. 5A to 5E illustrated alternative beam focusing and accelerating devices suitable for use with systems embodying the invention; and

FIG. 6 illustrates an energy selection device suitable for use with embodiments of the invention.

### DETAILED DESCRIPTION OF THE DRAWINGS

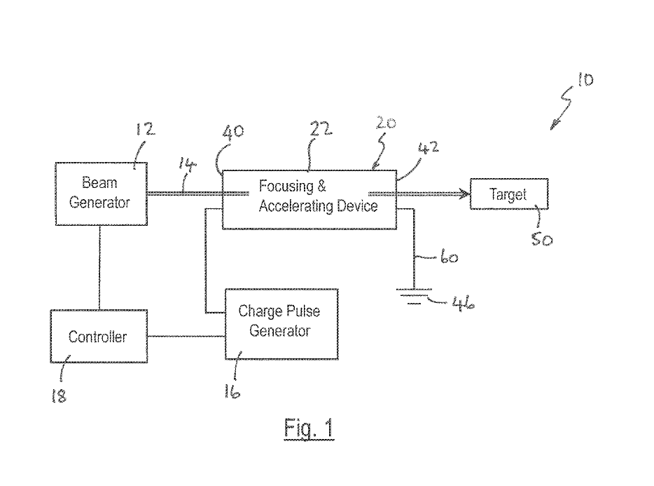

Referring now to FIG. 1 of the drawings, there is shown, generally indicated as 10, a schematic representation of a beam focusing and accelerating system embodying one aspect of the invention. The system 10 comprises a beam generator 12 for generating a beam 14 of electrically charged particles, typically an ion beam. In the illustrated embodiments, the beam 14 comprises a proton beam, although the invention is not limited by this. As such, the beam generator 12 may comprise any conventional proton source (e.g. a plasma-based device such as a duoplasmatron or a magnetron) and, optionally, one or more beam forming components (not shown). In alternative embodiments, the system may be configured for use with beams of other charged particles, especially positively charged particles, for example other ions (e.g. Hydrogen ions or Heavy ions), or alpha particles. Embodiments of the invention may be configured to operate on electrons or positrons. In any event, the beam generator 12 may comprise any conventional particle source and, optionally, one or more beam forming components as suits the type of particle being manipulated by the system.

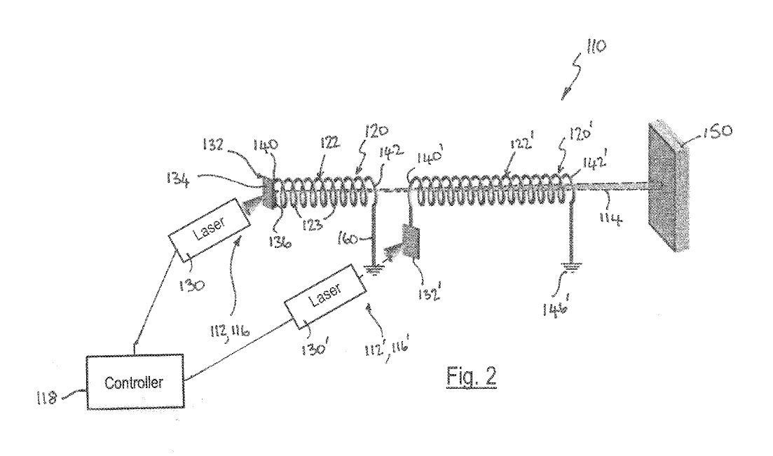

However, in preferred embodiments, for example the preferred system 110 of FIG. 2, beam generator 12 comprises a laser-driven ion beam generator (commonly known as a laser-driven ion accelerator). With reference to FIG. 2, a preferred system 110 embodying the invention is shown, in which the beam generator 112 comprises a charged particle accelerator, for example a laser-driven ion beam generator, comprising a laser 130 and a target, represented as target structure 132, formed from any suitable material that is capable of generating electrically charged particles when irradiated by a laser. The laser 130 is typically of the type referred to as intense (including ultra-intense, super-intense), and is targeted on the target structure 132. For example, the laser 130 is preferably capable of producing a laser output, preferably still laser pulses, having an intensity of greater than or equal to approximately 10¹⁸ W/cm². The laser 130 may for example comprise a Nd-Glass or Ti-Sapphire laser.

In preferred embodiments, the laser 130 is configured to irradiate the target structure 132 during use with one or more laser pulses, Each pulse may for example have a duration in the order of tens of femtoseconds (in the case of a Ti-sapphire laser) to picoseconds (in the case of an Nd-glass laser). In cases where more than one laser pulse is applied to the target structure 132, the time between consecutive pulses may depend on how quickly the target structure 132 and the focusing and accelerating devices 20, 120, if destroyed after each operational cycle, can be replenished. Typically, the laser pulses are applied to the target structure 132 at a rate of approximately 1 to 10 Hz.

The target structure 132 may take a variety of forms but is typically solid and thin (e.g. in the order of nanometres up to millimetres, e.g. approximately 10 to 100 micrometres) and may be single or multi-layered. The target may be formed from one or more materials, for example a metal (e.g. aluminium or gold), plastics, foam, diamond-like carbon, or any other material that is capable of generating an ion beam when irradiated by the laser. The target structure 132 typically comprises a foil (single or multi-layered) or a wire but may take any suitable form and need not be a regular or purposefully formed structure. In some cases the target structure may comprise what is known as target bulk. By way of example, when a foil is used as the target, it may for example have an area in the order of mm². In use, the laser 130 irradiates a first, or obverse, surface 134 of the target structure 132, typically with pulsed laser radiation. In response to the irradiation of the obverse surface 134, an ion beam, for example a proton beam, emanates from a second, in this example the reverse, surface 136 of the target 132. This may occur by any one or more of a number of known mechanisms including Target Normal Sheath Acceleration (TNSA), Light Sail Radiation Pressure Acceleration (LS-RPA), Collisionless Shock Acceleration (CSA), or Break-out Afterburner (BOA). In preferred embodiments, the beam generator 12, 112 is configured to produce a proton beam by TNSA. The characteristics of the beam generator 12, 112, including the laser and target structure characteristics, may be selected accordingly as would be apparent to a skilled person. More generally, the laser irradiates the target, typically with pulsed laser radiation, causing the target to produce a beam of charged particles, wherein the target is formed from any known material(s) for this purpose, in any suitable form, and wherein the generation of the charged particles occurs by any conventional mechanism.

The characteristics of the ion beam 14 may vary depending on the acceleration mechanism used to create it as would be apparent to a skilled person. For example ion beam spectra for TNSA and BOA mechanisms are typically exponential, while RPA produces narrower band of ion energies. Particle number, ion energy and divergence of the beam not only depends on the acceleration mechanism but also on the laser 130 and other parameters such as the characteristics of the target structure 132. As an example, employing the TNSA mechanism ˜10¹² protons of 10s of MeV energy may be obtained by the interaction of petawatt (10¹² Watt)laser focused to an intensity of ˜10²⁰ W/cm² on an aluminium foil having a thickness of between 10-100 micrometres.

In typical embodiments, the ion beam 14 is comprised of ion pulses, wherein each laser pulse incident on the target structure 132 generates one ion pulse. Each ion pulse is comprised of multiple charged particles, e.g. multiple protons (typically in the order of 10¹⁰ particles or more). Optionally, the laser pulse parameters may be adjusted (for example by polarisation gating) to generate multiple optical pulses from a single laser pulse, in which case multiple laser pulses may produce multiple ion pulses. In any event one intense pulse (i.e. a direct laser pulse or a pulse derived from a laser pulse) incident on the target 132 tends to produce one ion pulse of the beam 14. The duration of the generated ion pulses is typically similar to that of the laser pulse.

Referring again to FIG. 1, the system 10 includes a charge pulse generator 16 for generating electrical charge pulses. In preferred embodiments, the laser-driven ion beam generator 112 serves as the charge pulse generator 16, and as such is denoted in FIG. 2 by both 112 and 116. During use, interaction of intense laser 130 with the target 132 produces large population of relatively high energy electrons in the target 132. Some of the high energy electrons manage to escape the target 132 by overcoming target potential. The loss of electrons in the target is compensated by a flow of electrons from the ground, for example through a stalk 60, 160, or other ground connection, which may conveniently also holding the target 132 in a use position. Due to the transient loss of electrons, which occurs during the interaction of short intense laser pulses with the target 132, the flow of charge between the target 132 and ground occurs by means of a localised charge packet, or charge bubble. The amount of charge loss depends on the efficiency of hot electron production in the target and on target potential, which depends on target capacitance and so on target dimensions (and on target shape in some cases). The efficiency of hot electron production depends on the characteristics of the laser and target 132, for example laser intensity, laser energy, pre-pulse condition, angle of incidence on target, and target material. The strength of the charge pulse can be optimised by adjusting the laser and/or target characteristics.

Considering by way of example a simple embodiment such as that shown in FIG. 2 and in which it is assumed that the target 132 comprises a metallic foil with an area of the order of mm², above a peak laser intensity of 10¹⁹ W/cm² it is found that laser-to-electron conversion efficiencies of up to 50% can be achieved. Most of the laser energy absorbed by the target is carried by a forward moving hot electron population with an electron spectrum that can be approximated as an exponential:

dN/dE=(N₀/Up)exp(−E/Up)

with a temperature of the order of the ponderomotive potential of the incident laser (e.g. where Up=0.511 ((1+aₒ²/2)^{1/2}−1) MeV, where aₒ is the normalized laser vector potential). A small fraction of the hot electron population escapes and rapidly charges the target to a potential of the order of Up preventing the bulk of the hot electrons from escaping. Loss of electrons in the laser target is compensated by electrons flowing from the ground, for example, through a stalk 160 holding the target. However, due to the transient nature of the laser-target interaction, the charge is highly localised in space, within a moving packet or bubble, at any given point of time, producing a strong localised electric field typically of the order of 10¹⁰ V/m, which is orders of magnitude higher than the field possible by conventional accelerator technology.

Still referring to FIG. 1, the system 10 may include a controller 18 for controlling and co-ordinating the operation of the beam generator 12 and the charge pulse generator 16. In particular, the controller 18 may be configured to control the synchronisation of the ion beam 14 and the charge pulses. Conveniently, in preferred embodiments, the synchronisation of the ion beam 14, 114 and the charge pulse is achieved (at least for a first stage of the system 10, 110) by using a common laser driven ion accelerator 130, 132 to produce both the ion beam 14 and the charge pulse. Hence, each ion pulse of the ion beam 14, 114 is produced synchronously with a charge pulse. The controller 18 may take any suitable form, e.g. comprising a suitably programmed microprocessor. Conveniently, the controller 18 may be integrated with either one or both of the beam generator 12 and the charge pulse generator 16. For example, in the system 110 of FIG. 2, the laser 130 may include an integral controller.

The system 10 further includes a beam focusing and accelerating device 20. The device 20 comprises a body 22 through which the beam 14 passes in use. Accordingly, the beam generator 12 is aligned with the body 22 to direct the beam 14 into the body 22 via a first end 40, passes through the core of the body, and out of the body 22 through a second end 42. Preferably, the body's core is hollow although it may alternatively contain matter that allows the beam 14 to pass through it. The body 22 is configured to define a charge path (not shown in FIG. 1) from the first end 40 to the second end 42 along which electrical charge can travel. The charge path is preferably shaped to extend around the longitudinal axis of the body 22, and in use around the beam 14, as well as from end 40 to end 42. For example, the charge path may be substantially helical in shape with its longitudinal axis extending in an end-to-end direction of the body 22, preferably being substantially co-incident with the longitudinal axis of the body 22, and in use with the beam 14. The charge path may be formed in any convenient manner, typically electrically conductive material shaped to form a helical shape, or other appropriate shape. In this connection it is noted that some materials that would normally be considered as electrical insulators can become electrically conductive at the electrical potentials generated by systems embodying the invention. Therefore the term “electrically conductive” is intended to embrace any material that provides a path for the electrical charge pulses generated during use.

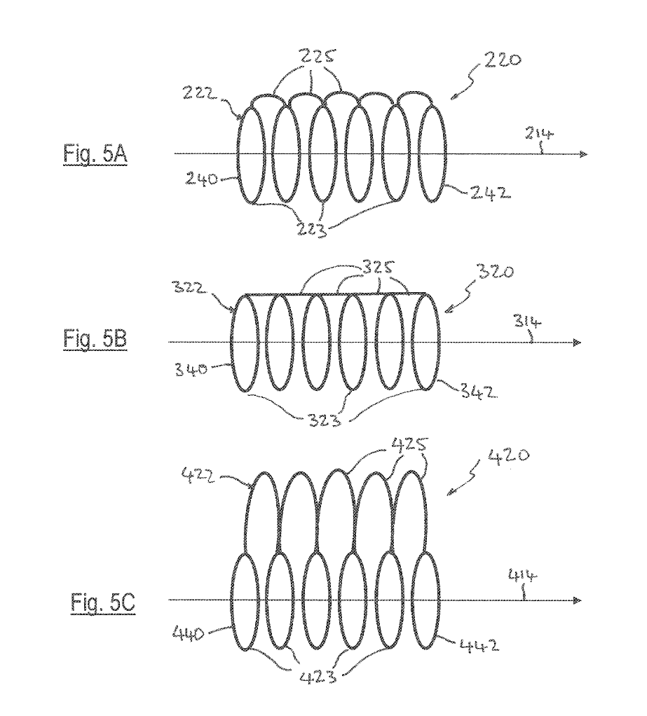

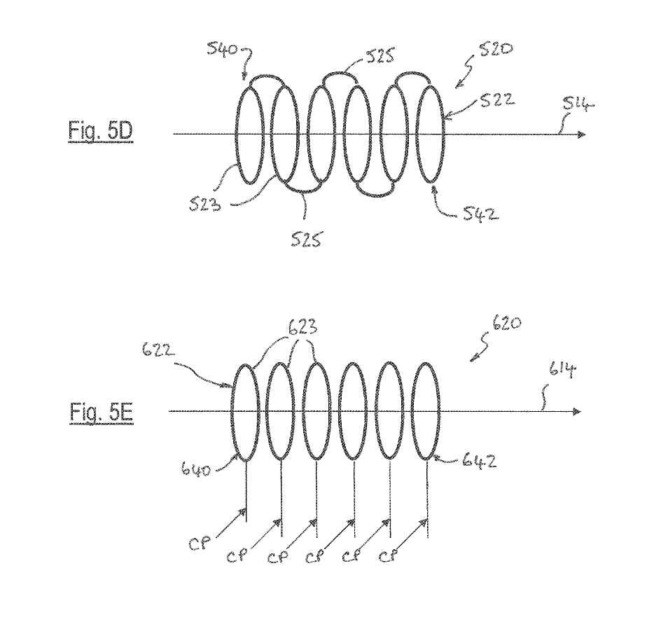

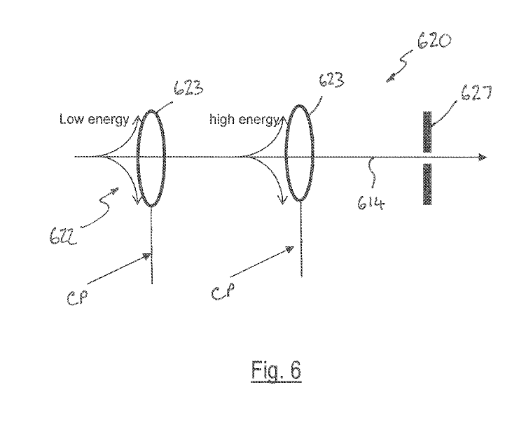

The charge path comprises a least one, but more typically a plurality of, loops (or turns), each loop being spaced apart from the or each adjacent loop in the end-to-end direction of the body 22. Adjacent loops may be contiguous, but are preferably spaced apart so as to define a gap therebetween, i.e. non-contiguous. The charge path may have a substantially constant transverse cross-sectional area, or diameter, or may have a varying transverse cross-sectional area. For example, the charge path may be substantially conical in shape, having a larger cross-sectional area at the target end 40 and a smaller cross-sectional area at the other end 42, with a gradually decreasing cross-sectional are in between. This allows more charged particles to be collection from the target 132. Once the ion beam is collimiated in the target end 40 of the device 22, reducing the diameter towards the end 42 facilitates focusing and accelerating field strengths on the ions. In preferred embodiments, the charge path is provided by a coil 122, which may for example be substantially cylindrical (as illustrated in FIG. 2) or substantially conical, or by a ring structure comprising a plurality of spaced-apart interconnected rings, as illustrated in FIGS. 5A to 5C by way of example.

The charge path, and preferably therefore each loop, is preferably substantially circular in shape (cross-section), but may alternatively take other shapes. The respective gap between each pair of adjacent loops may comprise an electrically insulating material, which may be solid, liquid or gaseous. Preferably however, there is substantially no matter between the loops, i.e. the charge path comprises a self-supporting, e.g. helical, structure in a vacuum or partial vacuum. To this end, all or part of the system 10 may be housed within a vacuum chamber (not shown), depending on the application as would be apparent to a skilled person.

It is noted that even if the target 132 is not connected to ground, the charge packet still flows from the target 132, i.e. through the body 22, 122 in the illustrated examples. Providing a connection to ground is preferred, particularly since the connector, e.g. stalk 60, 160, may conveniently serve the function of holding the target 132 with respect to the laser 130. Alternatively, if the body 22, 122 is held by non-contact support means (for example a magnetic field providing magnetic levitation), then the stalk 60, 160 may be omitted. The stalk 60, 160, or other support member, may be made from an electrically insulating or electrically conductive material. It is noted that the support member need not necessarily provide a connection to ground, and that in some embodiments no ground connection is provided. In such cases charges pulses may be reflected back into the body 22, 122 once they reach the end 42, 142. More generally, the support member (e.g. stalk 60, 160) and ground connection may be provided (or not) independently of each other. The support member (e.g. stalk 60, 160) and ground connection a preferably provided at the end 42, 142 of the body 22, 122, although may be located elsewhere.

During irradiation of the target 132 a charge packet formed in the target 132 is emitted from the target as a single charge pulse. The charge pulse travels at close to the speed of light, typically but not necessarily to ground or other point of reference potential. In the illustrated embodiments, the charge pulse travels along the device 22, 122 as is described in more detail hereinafter.

The charge pulse is created by interaction of a pulse from the laser 130 with the target 132. Typically one charge pulse is created per pulse from the laser incident on the target 132 (which may be a direct laser pulse or a pulse derived therefrom). The duration of the charge pulse is determined by and is typically similar to the duration of the laser pulse that creates it. The magnitude of the charge pulse is affected by laser characteristics including laser intensity, laser energy, pre-pulse condition and angle of incidence on target. The system 10 is configured such that the duration of the charge pulse is sufficiently short that the charge travels along the device 22 as a discrete pulse. This may be arranged by selection of one or more relevant parameters of the system 10, including the length of the path along which the charge travels through the device 22 and the duration of the laser pulse.

In preferred embodiments, and as illustrated in FIG. 2, the beam focusing and accelerating device 120 comprises an electrically conductive helical coil 122, which provides the hollow body and the helical charge path. The coil 122 comprises a plurality of loops 123 mutually spaced apart in the end-to-end (or longitudinal) direction, preferably non-contiguously. The loops together provide the helical charge path from end 140 to end 142. The coil 122 is preferably metallic. By way of example, the coil 122 may be in the order of approximately 0.01 metres in length from end-to-end. The coil 122 may have a substantially uniform diameter of, for example, approximately 1 mm or less. The coil 122 is conveniently formed from metallic wire, for example approximately 0.1 mm in diameter. The coil 122 may for example have approximately 15 loops.

The charge pulse generator 16, 116 is coupled to the beam focusing and accelerating device 20, 120 to deliver at least one, or a train of, electrical charge pulses to the hollow body 22, 122. Typically, this is achieved by electrically connecting the charge pulse generator 16, 116 to one end 40, 140 of the body 22, 122. For example, in the preferred embodiment of FIG. 2, the target structure 132 is connected to the end 140 of the helical coil 122, e.g. by direct connection of the target 132 to the coil 122 by welding, fusing, gluing or any other convenient fixing means, which may or may not be electrically conductive. Because the location of this connection is close (e.g. in the order of millimetres) to the laser-target interaction point, any inherently non-conductive fixing material that may optionally be used to effect the connection will ionize during use to become electrically conductive. The other end 42, 142 of the beam focusing and accelerating device 20, 120, and in particular the hollow body 22, 122 is connected to a reference potential point, conveniently electrical ground 46, 146, e.g. by stalk 60, 160 or other support member or other ground connection. This provides a termination for the charge flowing through the device 20, 120 and conveniently also provides means for holding the target 132. For example, in the system 110 of FIG. 2, the coil 122 provides a conduit along which the charge pulses that form in the target 132 travel from end 140 to end 142.

During use, electrical charge pulses generated by the charge pulse generator 16, 116 are delivered to the body 22, 122 at one end 40, 140 and travel along the helical charge path defined by the body 22, 122, to the other end 42, 142. The helical charge path causes the charge pulses to travel around the hollow core of the body 22, 122, and in particular around the longitudinal axis of the body 22, 122, as well as in the longitudinal direction from end-to-end. This creates a non-zero electrical field within the hollow core of the body 22, 122. Due to the relatively short duration of the charge pulse in comparison with the length of the charge path, the charge only spreads over a limited number of loops in the coil at any given time during its propagation through the body 22, 122, i.e. it is not simultaneously present in all loops of the coil. Therefore at any given time during the transit of the charge pulse from end 40, 140 to end 42, 142, a strong electric field exists over a limited region of space surrounding the, or each, loop charged by the charge pulse, spanning over a length of the body 22, 122 that is less than its full length. The electric field strength is stronger near the coil and decreases gradually towards the longitudinal axis of the body 22, 122, The electric field at any point in space can be resolved into two orthogonal components—a transverse component, which has the effect of controlling the divergence (i.e. focusing) of the beam 14, 114, and a longitudinal component, which has an accelerating or decelerating effect on the beam 14, 114, depending on the position of the particles in the beam 14, 114 with respect to the position of the charge pulse in the body 22, 122, in particular the relative longitudinal positions of the charge pulse and the respective particle. The strength of each electric field component depends on various factors, such as the linear charge density in the coil 22, 122, geometry, diameter and pitch (i.e. spacing between adjacent loops) of the coil 22, 122.

As the charge pulse propagates forward along the body 22, 122 from end 40, 140 to 42, 142 (with a speed close to the speed of light) its corresponding electric field also moves in the longitudinal direction of body 22, 122 with a speed depending on the geometry, diameter and pitch of the coil 22, 122. Therefore, for a given speed of the particles in the beam 14, 114 (which is typically in the order of nanoseconds), or, to manipulate particles of a particular energy in the case of a multi-energy input beam 14, 114, the shape and/or dimensions (e.g. length, pitch and/or diameter) of the coil 22, 122 can be selected in order to achieve synchronisation of the movement of the electric field region with the desired particles (of an ion pulse of the beam 14, 114). Hence, by matching the shape and/or size of the charge path to one or more characteristics (e.g. speed and/or energy level), the electrical field created by the charge pulse has the desired focusing and accelerating effect on the relevant charged particles. This enables the system 10, 110 to perform energy selection of particles in the case where the beam 14, 114 comprises particles with different energy levels.

Moreover, due to the manipulation of the beam parameters that are possible for part of the input energy spectrum, there are several ways to tailor the energy spectrum. For example, one can use a beam spatial filter (e.g. a pinhole) placed at the focal plane of the desired energy particles in order to filter the particles of other energies which are not focused due to improper synchronisation with the charge bubble travelling along the body 22, 122.

It is noted that, to account for the acceleration of the charged particles as they pass through the device 20, 120, one or more characteristics of the coil 122 may vary along the length of the coil 122 in order to maintain synchronism between the propagation of the ion pulse and the charge pulse. This may for example be achieved by adjusting the pitch between loops and/or by adjusting the diameter (or width) of the loops.

In typical embodiments, the propagation of the charge pulse along the charge path is synchronised with an ion pulse of the beam 14, 114 so that the charge pulse has the desired focusing and accelerating effect on the charged particles of the ion pulse. However, the invention is not limited to use with pulsed ion beams. For example, and particularly in embodiments where the beam generator 12 and charge pulse generator 16 are separate, the beam 14 may be continuous rather than pulsed, in which case the propagation of the charge pulse has a focusing and accelerating effect only on those particles that are synchronous with it.

The characteristics, including magnitude and duration, of the charge pulse typically depends on one or more characteristics of the system 10 such as the characteristics of the laser pulses, the target 132 and the focusing and accelerating device 20. Typically, the pulse is of the duration of approximately 10 to 100 picoseconds and linear charge density of approximately 10-100 micro-Coloumb/meter. In typical embodiments, propagation of the pulse along the body 22, 122 coincides with propagation of one ion pulse through the body 22, 122, although this need not necessarily be the case.

The beam generator 12, 112 is positioned with respect to the focusing and accelerating device 20, 120 such that the beam 14, 114 travels through the body 22, 122 from end-to-end. Preferably, the alignment is such that the beam 14, 114 travels substantially along the longitudinal axis of the body 22, 122. More preferably, the path is substantially parallel with or coincident with the longitudinal axis of the body 22, 122. In the preferred embodiment shown in FIG. 2, this is achieved by aligning the target structure 132 with the coil 122 such that the reverse surface 136 faces and is in line with the hollow core of the body 122. Preferably, the target structure 132 is fixed directly or indirectly to the coil 122 with its reverse surface 136 facing, and preferably against, the open end 140 of the coil 122. As a result, the beam 114 emanating form the reverse face 136 travels through the coil 122 from end 140 to end 142. More generally, the target is aligned with the body/coil so that the beam 14, 114 travels through the body/coil.

In the illustrated embodiments, the direction of travel of the beam 14, 114 and the charge pulse(s) through the body 22, 122 is the same, i.e. in a direction from end 40, 140 to end 42, 142. During use, the electrical field generated within the hollow core of the body 22, 122 has the effect of focusing and accelerating the beam 14, 114. In particular, the radial and longitudinal components of the moving electric field created within the hollow core of the body 22, 122, act, respectively, towards focusing and acceleration of the protons (or other charged particles) that are synchronised with the charge pulse travelling along the helical path. Protons, or other charged particles, that are not synchronised with, e.g. lagging behind, the charge pulse may be decelerated by the longitudinal component of the electrical field.

In FIGS. 1 and 2, the system 10, 110 is shown with beam 14, 114 aimed at a target 50, 150. The nature of the target 50, 150 depends on the application. The target 50, 150 may for example be a further device, object or person.

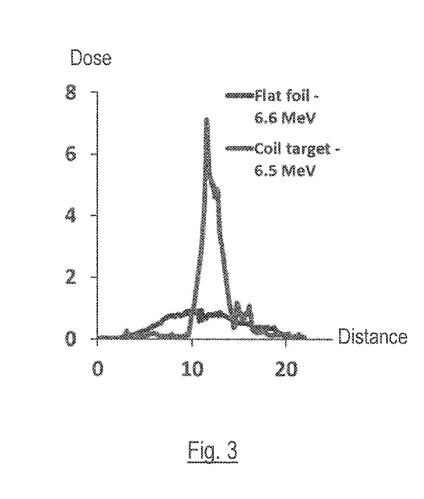

FIG. 3 illustrates how the system 110 focuses a proton beam 114 in comparison with a similar system (not illustrated) without the coil 122. It can be seen that, for protons having similar energies levels (approximately 6.5 MeV in this example), the beam 114 emanating from the target 132 is focused on a region of a target 150 of approximately 5 mm in width, and most intensely in a region of approximately 2 mm in width, in comparison with a width of approximately 15 mm for an unfocused beam produced by a comparable system without the coil 122. Moreover, it can be seen that the dose deposited by the protons of the focused beam 114 in the focused region is approximately 7 times higher than for the unfocused beam. For the results shown in FIG. 3, the system 110 employs a laser 130 having a power in the order of terawatts and the beam generator 112 produces a beam comprising protons of energy up to 10 MeV from a target structure 132 comprised of gold foil (e.g. approximately 0.001 m by 0.001 m in area and less than 0.01 mm thick).

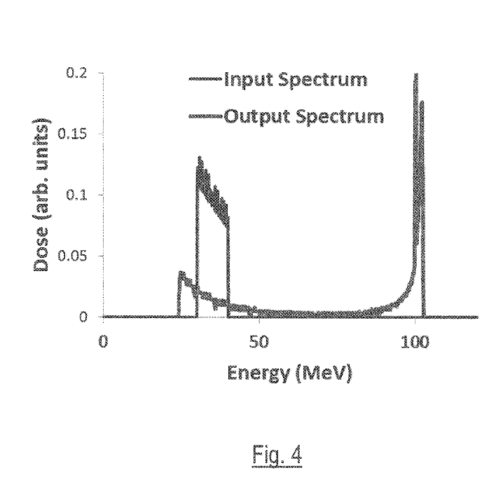

FIG. 4 illustrates how a system embodying the invention can accelerate, i.e. increase the energy of, the particles in the beam 14, 114. For the results shown in FIG. 4, the system 110 employs a laser 130 having a power in the order of petawatts and the beam generator 112 produces a beam comprising protons of energy up to approximately 30-40 MeV. It can be seen that particles entering the focusing and accelerating device 20, 120 with energy of approximately 40 MeV can reach approximately 100 MeV for the case where the body 22, 122 is approximately 0.01 m in length, where the longitudinal electric field strength at the core of the body 22, 122 produced by the travelling charge pulse reaches the order of 10¹⁰ V/m.

In one example, the system 10, 110 harnesses the power of the travelling charge packet or bubble in order to simultaneously focus and accelerate 10s MeV protons to 100 MeV through a coil 122 of approximately 0.01 m in length. The packet, or pulse, of charge originating at the target flows along the coil 122 to ground 146 via the helical path. In this example, experimental data indicates that the flow of charge along the coil 122 be characterised as a localised charge bubble/packet, with Gaussian rise and decay profile of about 10 and 20 ps respectively, and a velocity at approximately the speed of light.

In general, the strength of the electric field produced by the system 10, 100 scales with incident laser parameters, such as energy and intensity.

In FIGS. 1 and 2, the system 10, 110 is shown with beam 14, 114 aimed at a target 50, 150. The nature of the target 50, 150 depends on the application. The target 50, 150 may for example be a further device, object or person.

Systems embodying the invention may include a multi-stage focusing and accelerating device. For example, in FIG. 2 the system 110 includes a two-stage focusing and accelerating device 120 in which each stage comprises a coil although it will be understood that the focusing and accelerating device of any stage may take alternative forms. The first stage 120 comprises the coil 122 described above. The second stage 120′ comprises a second coil 122′, which may be the same as or similar to the coil 122. One end 140′ of the coil is coupled to a charge pulse generator 116′, the other end 142′ typically being connected to a reference potential 146′. In this example, the charge pulse generator comprises a laser 130′ targeted on a target structure 132′, and may be the same as the charge pulse generator 116. The coils 122, 122′ are aligned with one another so that the beam 114 passes through the core of each coil 122, 122′. Preferably, the coils are aligned to share a common longitudinal axis.

Referring to the system 110 of FIG. 2, the controller 118 precisely controls the timing of the lasers 130 and 130′ in such a way that the lasers arrive at the respective targets 132 and 132′ defined by the system 110.

One or more characteristics of the, or each, coil 122, 122′ may be selected (independently of the other coil(s)) in order to obtain desired focusing and/or acceleration characteristics. The selectable coil characteristics include: shape (including for example helical and any of the alternatives illustrated in FIG. 5A to 5D) end-to-end length, inter-loop pitch, loop width (or diameter). One or more further coils or other focusing and accelerating devices (not shown) may provided in a manner the same or similar to coil 122′.

The first stage components 112, 116, 122 may be considered as the beam generator for the second (and any subsequent) stage. The second stage may be considered as the target for the first stage.

Referring now to FIGS. 5A to 5E, alternative focusing and accelerating devices are indicated as 220, 320, 420, 520 and 620. Each device 220, 320, 420, 520, 620 comprises a body 222, 322, 422, 522, 622 comprising a plurality of loops, or rings 223, 323, 423. 523, 623. The loops 223, 323, 423, 523, 623 are preferably spaced apart from one another, but may be contiguous. The loops are preferably substantially co-axial. Each loop 223, 323, 423, 523. 623 encircles, during use, the ion beam 214, 314, 414, 514, 614. It will be apparent that the loops 223, 323, 423, 523, 623 are similar to the loops 123 of the coil 122 of FIG. 2.

In the embodiments of FIGS. 5A to 5D, adjacent loops are interconnected by a respective link member 225, 325, 425, 525 such that the hollow body 222, 322, 422, 522 defines a charge path from end 240, 340, 440, 540 to end 242, 342, 442, 542 that encircles the axis along which the beam travels. As such, a charge pulse travelling from loop to loop and from end 240, 340, 440, 540 to end 242, 342, 442, 542 has an accelerating/decelerating and focusing effect substantially similar to those described above. The loops and the links may together be said to form a coil, albeit not a helical one. One or more parameters of the loops, for example diameter, inter-loop spacing and thickness, may be selected to provide the desired acceleration and focusing of particles as is described above in relation to FIG. 2. Moreover, the length of the link members may be selected to create a desired rate of charge propagation along the body 222, 322, 422, 522 (longer links slow the longitudinal propagation of charge and shorter links increase it). The loops 223, 323, 423, 523 may be substantially circular, or may take other shapes. The loops and links may be formed from any suitable material, e.g. an electrically conductive material such as metal, The device 220, 320, 420, 520 may be substituted for the device 22, 122 in the systems 10, 110 of FIGS. 1 and 2 and so corresponding descriptions of configuration and operation apply as would be apparent to a skilled person.

In the embodiment of FIG. 5E, the loops 623 are not interlinked. Each loop 623 has a respective charge pulse delivered to it as illustrated by arrows CP. This may be achieved by a common charge pulse generator (not shown) that is capable of delivering a charge pulse to each loop separately, or by a respective charge pulse generator (not shown) for each loop 623. More generally, one or more charge pulse generators may be provided, each providing charge pulses to one or more respective loops. For example, a charge pulse may be provided to each loop 623 in the same manner as described for the second stage 120′ of the multi-stage focusing and accelerating device 120′ of FIG. 2. The operation of the charge pulse generator(s) is controlled (conveniently by a common controller (not shown)) a respective charge pulse is delivered to each loop 623 in sequence from the loop at end 640 to the loop at end 642. In typical embodiments where the beam 614 comprises ion pulses, the sequential delivery of the charge pulses is synchronised with the passage of an ion pulse along the body 622, as described above in relation to FIGS. 1 and 2. It will be seen that the embodiment of FIG. 5E may be considered as a multi-stage focusing and accelerating device, similar to that of FIG. 2, wherein each stage comprises a focusing and accelerating device having a body with only one loop.

In typical embodiments, the speed of the charge pulse is close to speed of the light and so charges each loop 22, 223 323, 423, 523, 623 almost instantly, particularly in comparison with the ion pulse transit time, and especially when the loop diameter is of the order of hundreds of microns.

It will be seen that in preferred embodiments, the loops 22, 223, 323, 423, 523, 623 encircle the ion beam and preferably comprise a continuous structure such as a complete ring or a turn of a helical coil. However, in alternative embodiments (not illustrated) one or more of the loops may be non-continuous, e.g. be comprised of multiple parts interspaced by one or more gaps. In such cases, each of the multiple parts may be supplied with a respective charge pulse (preferably simultaneously) from a respective charge pulse generator or, in cases where the gap(s) allow transmission of the charge pulse from one part to another, by a common charge pulse generator. In any case the loops or other charge carrying structures are preferably disposed substantially perpendicularly to the beam axis.

It is advantageous that, during use, the charge pulse surrounds the beam axis to have the desired focusing effect (which is caused by the transverse electric field of the charge pulse), otherwise the beam may suffer deflection from the longitudinal axis, and/or be focused in one plane but not others. Regarding the longitudinal component of the charge pulse's electric field (which effects acceleration of the charged particles), it is not essential to have symmetry around the beam axis. However, the beam can go off the longitudinal axis if it is not guided simultaneously by a symmetrical focusing field. Therefore while embodiments of the invention may include a focusing and accelerating structure configured to provide one or more charge path does not encircle the beam axis (e.g. one or more charge paths running parallel to the beam axis), is preferred to provide the loop type charge paths described herein.

As described above with reference to FIG. 2, the helical charge path facilitates synchronisation of the charge pulse with the ion beam along the coil axis. For 10s MeV protons (for example), the speed is 1/10 of the speed of light and the charge pulse moves with close to speed of light. The helical geometry provides enough delay to the charge pulse to achieve the desired synchronisation. However, the device 122 accelerates the protons simultaneously and so it may be necessary to change one or more of the coil's parameters (e.g. gradually increase the pitch of the coil) to maintain the synchronisation over the full length of the coil.

Up to around 100 MeV (where the speed of proton is approximately ½ of speed of light) it may be possible to reduce the coil diameter and increase the coil pitch to achieve the synchronisation between the charge pulse and the proton beam. However, at some point the coil may not work efficiently as the pitch becomes significantly larger than the coil diameter. In such cases, using a device 220, 320, 420, 520 of the type shown in FIGS. 5A to 5D may be advantageous since the length of the link members can be selected to match with the speed of the protons. For example, for high energy protons with speed close to speed of light, the links may provide a direct connection in the longitudinal direction (FIG. 5B).

The configuration of FIG. 5B may also work for low energy protons as well, but alternatively for low energy protons longer links between loops may be provided (FIGS. 5A and 5C) to achieve the desired synchronisation between the charge pulse and ion beam, The length of the respective links may vary along the ring structure, e.g. be longer near end 240, 340, 440, 540 and shorter near end 242, 342, 442, 542.

In a multi-stage system, one or more helical coil 122 may be used in series with one or more ring structure coil 222, 322, 422. In such cases, the or each ring structure coil typically follows the or each helical coil 122.

Preferred embodiments, in particular the embodiment illustrated in FIG. 2, of the invention exhibit one or more of the following advantageous features:
1. The use of relatively thin wires to increase the localised charge density, and hence the strength of the electric field around the beam 14, 114. For example, a wire having a thickness of approximately 50 to 100 microns, or less, may be used.
2. A relatively long wire is used to create the helical path, enabling the focusing/accelerating electric field to be applied over a longer time span. For example, the wire may be between 1 to 10 cm depending on the diameter, pitch and length of the coil.
3. The helical path geometry for the flow of the charge pulse around the beam 14, 114 axis, allows synchronisation of the charge flow with a desired section of the input proton spectrum by varying the coil diameter and pitch.

Referring now to FIG. 6, it is described how systems embodying the invention may be used to perform energy selection, and so to sever as an energy selector device 620. If the input beam 614 comprises charge particles with different energies, different energy ions will arrive at the loops 623 at different times due to their time of flight. Each loop 623 may be charged with a charge pulse at a respective appropriate time to synchronise with particles of the ion beam 614 at the desired energy in order to tailor the energy spectrum of the input beam. Each loop 623 acts like a shutter, or a transient deflector, for the ions. The ions within the desired energy range pass through the loops 623 undeflected, while others suffer some degree of deflection and will diverge from the longitudinal axis. A spatial aperture 627 may be provided at the end of the loop structure 622 aligned with the longitudinal axis in order to collect the ions within the desired energy range.

For the purposes of energy selection it is not necessary to use loops 623. The loops 623 may be replaced by other types of charge carrying structure, for example a mesh or a foil. Using a foil (e.g. of sub-micron thickness) creates relatively little scattering of the ions. In any case the ion beam 614 can be refocused after the energy selection by using, for example, either a permanent magnet quadrupole or a focusing device 22, 122, 322, 422, 522. A loop or a mesh is preferable because of its relatively low surface area, which facilitate increase of charge density and hence the electric field strength.

By way of example, the energy selection device 620 may be incorporated in line with one or more focusing and accelerating device embodying the invention, e.g. in-line between two focusing and accelerating device such as those shown in FIG. 2 in order to filter out the unwanted ions entering the second stage.

The longitudinal axis of the body 22, 122 (and correspondingly of the core) may be rectilinear, for example as shown in the illustrated embodiments, but may alternatively be curved, This may be achieved by shaping the body 22, 122 to the desired shape, e.g. by selecting the angular displacement between successive coils/loops of the body to provide the desired shape of longitudinal axis for the beam to travel along.

In any embodiment, one or more characteristics of the, or each, loop of the body may be selected (independently of the other loop(s)) in order to obtain desired focusing and/or acceleration characteristics and/or to synchronise the movement of the charge pulses along the charge path with the movement of the charged particles through the core. The selectable coil characteristics include: shape (including for example helical and any of the alternatives illustrated in FIG. 5A to 5D) end-to-end length of the body, inter-loop pitch, loop width (or diameter). For example the pitch between adjacent coils/loops, and/or width of the coils/loops, may be constant along all or part of the body 22, 122, or may increase or decrease in the forward direction along all or part of the body. The body 22, 122 may for example be substantially cylindrical along all or part of its length or substantially conical along all or part of its length. In one specific example (not illustrated), in a first portion of the body 22, 122, e.g. starting at end 40, 140, successive coils/loops have a diameter that decreases in the forward direction (e.g. the body may be substantially conical in this portion), and in a second portion of the body located after, preferably directly after, said first portion, successive coils/loops have a diameter that is substantially constant in the forward direction, and preferably of substantially the same diameter as the last coil/loop in the first portion (e.g. the body may be substantially cylindrical in this portion). In this embodiment, the first portion of the body has the effect of focusing a relatively high number of charged particles, while the second portion is particularly adept at accelerating them once focused by the first portion.

The invention is not limited to the embodiment(s) described herein but can be amended or modified without departing from the scope of the present invention.

1. A system for focusing and accelerating a beam of electrically charged particles, the system comprising:
a beam generator for generating said beam;
at least one charge pulse generator for generating at least one electrical charge pulse;
at least one focusing and accelerating device comprising a body with a core, said body defining a charge path extending along said body;
wherein said beam generator is arranged to direct said beam through said core; and
wherein said at least one charge pulse generator is coupled to said body to deliver said at least one charge pulse to said charge path.

2. A system as claimed in claim 1, wherein said body comprises electrically conductive material shaped to define said charge path.

3. A system as claimed in claim 1, wherein said charge path extends around the longitudinal axis of said core.

4. A system as claimed in claim 1, wherein said charge path comprises at least one loop, preferably a plurality of loops mutually spaced apart in the direction of the longitudinal axis of said core, wherein adjacent loops are spaced apart to define a gap therebetween or are contiguous.

5.-6. (canceled)

7. A system as claimed in claim 3, wherein said charge path is substantially helical in shape.

8. A system as claimed in claim 4, wherein each loop is connected to the, or each, adjacent loop by a respective link member.

9.-10. (canceled)

11. A system as claimed in claim 4, wherein said at least one loop extends around the longitudinal axis of said core, and wherein said core is preferably hollow.

12. (canceled)

13. A system as claimed in claim 1, wherein said body comprises a coil, preferably a helical coil, said coil being shaped to define said charge path.

14.-15. (canceled)

16. A system as claimed in claim 1, wherein said body comprises a plurality of rings, each ring optionally being connected to the, or each, adjacent ring by a respective link.

17.-19. (canceled)

20. A system as claimed in claim 1, wherein said beam generator and/or said at least one charge pulse generator comprises a charged particle accelerator, for example a laser driven ion accelerator.

21. A system as claimed in claim 1, wherein said beam generator comprises a laser targeted on a first, for example obverse, surface of a target to cause said beam to emanate from a second, for example reverse, surface of said target, said target being aligned with an open end of said core so that said beam is directed into said core via said open end, and wherein said second surface is preferably located against said open end, and wherein, optionally the, or each, target is electrically connected to electrical ground, preferably at an end of said body opposite where said at least one charge pulse is delivered in use to said charge path.

22.-23. (canceled)

24. A system as claimed in claim 1, wherein said at least one charge pulse generator comprises a laser targeted on a first, for example obverse, surface of a target structure, said target structure being coupled to said charge path, and wherein, preferably, said target structure is connected, preferably electrically connected during use at least, to said charge path.

25.-26. (canceled)

27. A system as claimed in claim 1, wherein the beam generator and said at least one charge pulse generator are provided in combination by a laser targeted on a first, for example obverse, surface of a target structure to cause said beam to emanate from a second, for example reverse, surface of said target structure, said target structure being aligned with an open end of said core so that said beam is directed into said core via said open en, said target structure being coupled to said charge path.

28. A system as claimed in claim 24, wherein said target structure comprises a foil or wire.

29. (canceled)

30. A system as claimed in claim 1, wherein said beam comprises an ion beam or a proton beam.

31. (canceled)

32. A system as claimed in claim 1, further comprising one or more additional focusing and accelerating devices aligned with a first focusing and accelerating device, and wherein a respective charge pulse generator is preferably coupled to each focusing and accelerating device.

33. (canceled)

34. A system as claimed in claim 1, wherein said charge pulse generator is coupled to a first end of said charge path, and wherein, optionally, the other end of said charge path is coupled to a support member, said support member optionally being electrically conductive to provide an electrical connection between said other end of said charge path and electrical ground.

35.-37. (canceled)

38. A system as claimed in claim 1, further including means for controlling said beam and the delivery of said at least one charge pulse to synchronise the passage of at least some of said electrically charged particles through said core with the passage of said at least one charge pulse along said charge path, and wherein optionally said beam comprises charged particles with different energies, and wherein said controlling means is configured to synchronise the passage of at least some of said electrically charged particles within a selected energy range through said core with the passage of said at least one charge pulse along said charge path.

39.-40. (canceled)

41. A system as claimed in claim 1, further including means for controlling the delivery of said at least one charge pulse to said charge path, preferably such that only one charge pulse is present in said charge path at a time.

42. A system as claimed in claim 1, further including means for controlling said beam generator such that only one pulse of said beam is present in said core at a time.

43. A system as claimed in claim 1, further including means for controlling said beam and the delivery of said at least one charge pulse to synchronise the passage of a pulse of said beam through said core with the passage of a charge pulse along said charge path, and wherein optionally the shape and/or size of said charge path is selected to facilitate synchronisation of the passage of at least some of said electrically charged particles through said core with the passage of said at least one charge pulse along said charge path, and wherein optionally the shape and/or size of said charge path is selected to facilitate synchronisation of the passage of a pulse of said beam through said core with the passage of a charge pulse along said charge path.

44.-56. (canceled)

57. A system as claimed in claim 1 wherein said body is electrically connected to electrical ground, preferably at an end of said body opposite where said at least one charge pulse is delivered in use to said charge path.

58. A method of focusing and accelerating a beam of electrically charged particles using a focusing and accelerating device comprising a body with a core, said body defining a charge path extending along said body, the method comprising:
generating said beam;
generating at least one electrical charge pulse;
directing said beam through said core; and
delivering said at least one charge pulse to said charge path.

59. A system for performing energy selection on a beam of electrically charged particles with different energies, the system comprising:
a beam generator for generating said beam;
at least one charge pulse generator for generating at least one electrical charge pulse;
at least one energy selection device comprising a body with a core, said body defining a charge path extending along said body;
wherein said beam generator is arranged to direct said beam through said core; and
wherein said at least one charge pulse generator is coupled to said body to deliver said at least one charge pulse to said charge path.

60. (canceled)

61. A method as claimed in claim 58 further including synchronising the passage of at least some of said electrically charged particles within a selected energy range through said core with the passage of said at least one charge pulse along said charge path.
